(19) United States
(12) Patent Application Publication
(10) Pub. No.: US 2020/0130494 A1
(43) Pub. Date: Apr. 30, 2020

(54) Fiber Screens

(71) Applicant: Danny Roy Fiber, Palm Harbor, FL (US)

(72) Inventor: Danny Roy Fiber, Palm Harbor, FL (US)

(21) Appl. No.: 16/663,920

(22) Filed: Oct. 25, 2019

Related U.S. Application Data
(60) Provisional application No. 62/750,687, filed on Oct. 25, 2018.

(51) Int. Cl. B60J 11/06

(52) U.S. Cl. CPC B60J 11/06

(57) ABSTRACT

A screen apparatus provides protection of an exterior part of a stationary vehicle from any potential damages caused by sun exposure, weather, etc. The apparatus can be detachably and noninvasively applied to the vehicle using detachable fasteners. The apparatus comprises at least one planar indicium that permits a user to personalize the apparatus to their aesthetic. Additionally, the apparatus offers a tiered or overlapping modular indicium to facilitate adjustment and further personalization of the screen. An electrical assembly comprising a power storage and a processor can offer the user interactive control of a speaker and illumination system using a switch and/or a personal computing device. Thus, the apparatus addresses the conventional detrimental assignment of screen elements of a vehicle and strengthens the personalization of screens to the user through a modular indicium alongside an electrical assembly to facilitate the manipulation of illumination and sound.

The current application claims a priority to the U.S. Provisional Patent application Ser. No. 62/750,687 filed on Oct. 25, 2019.

### FIELD OF THE INVENTION

The present invention relates generally to screens. More particularly, the present invention relates to modularly assignable screens that can be detachably and noninvasively attached to a vehicle body and provide interactive features and mutable aesthetics.

### BACKGROUND OF THE INVENTION

Presently, the application of screens, particularly to those in the automotive industry for external use, is constrained to invasive fastening and mounting means that perforates the body of a vehicle. In one scenario, a recreational vehicle (RV) typically may make use of a screen applied over the wheels to mitigate sun exposure damage applied to the oft-stationary vehicle. However, to apply this screen or shroud, the screen itself may conventionally be bolted to the exterior hull of the vehicle. This can introduce moisture, rust, and damage to the hull thereat, either preventing or hindering the removal of the screen prior to the use of the vehicle. As such, it is both detrimental to the body of the vehicle and tedious to a user to apply and remove the screen element in such a circumstance. Further, the conventional screen used in such endeavors is often non-porous, preventing the ventilation of trapped vapors beneath a vehicle, thereby concentrating moisture and inviting detrimental oxidation to apply to the underside of the vehicle. Further still, in deference to the recreational vehicle, the user typically enjoys the exterior world once the user has settled and parked the recreational vehicle. However, the conventional screens applied lack any aesthetical merit, or means of personalization thereon, and do not enhance the experience of the user in any discernable manner apart from protecting the wheel wells.

It is therefore the objective of the present invention to offer a detachable and noninvasive screen that can be applied to a vehicle, such as an RV, to protect exterior parts such as wheels from sun exposure damage and other potential damages applied to the oft-stationary vehicle. The detachable and noninvasive screen can be attached to the vehicle or RV body using detachable fasteners and provide a plurality of interactive features and mutable aesthetics. The detachable fasteners may be administered and mounted to the extraneous surface of the RV through a mounting device. Preferably, the mounting device is operable through suction, thus affording the user a detachable and modular fastening system that may be administered and removed at the user's convenience. Afterwards, the screen may be engaged to the detachable fasteners through a plurality of apertures, affording the user to again modularly attach the screen to the detachable fasteners at the user's convenience. It will be further appreciated that the screen may comprise at least one planar indicium that permits the user to personalize the assembly to their aesthetic. In addition to the modularity offered by the exemplified embodiment, it will be further appreciated that the apparatus affords the user a tiered or overlapping optional modular indicium, whereupon the user may assign the aforementioned to at least one side of the screen to facilitate adjustment and further personalization of the screen. Further still, it will be appreciated that through an optional weight biasing bar contained within bar cavities therein, a power storage and processor system may be disposed. The at least one illuminator, and at least one speaker may be operated by the user through at least one switch to afford greater engagement with the screening element. The user may impact the lighting or sound of an immediate area more directly while simultaneously offering the user greater personalization. Thus, through the exemplified embodiment does the apparatus address the conventional detrimental assignment of screen elements, in particular, those of RVs, through a modular mounting device and coupler to a screen element with personalized indicia thereon. Through further elaboration the apparatus strengthens the personalization of the screen to the user through a modular indicium assignment system alongside a processor system that can facilitate the manipulation of illumination and sound.

### SUMMARY OF THE INVENTION

A detachable and noninvasive screen apparatus, also called “Fiber Screen”, offers protection to an exterior part or surface of a stationary vehicle from any potential damages caused by sun exposure, weather, insects, animals, etc. The screen apparatus can be detachably and noninvasively applied to an exterior surface of the vehicle, such as a recreational vehicle (RV), to protect exterior parts such as wheels, tires, etc. The screen apparatus can be attached to the vehicle's body using detachable fasteners and provide a plurality of interactive features and mutable aesthetics to a user.

The detachable fasteners of the screen apparatus may be administered and mounted to the extraneous surface of the vehicle through a mounting device. The mounting device may operate through suction, and/or magnetism, thus affording the user a detachable and modular fastening system that may be administered and removed at the user's convenience. The screen apparatus may be engaged to the detachable fasteners through a plurality of apertures, affording the user to again modularly attach the screen to the detachable fasteners at the user's convenience.

The screen apparatus may comprise at least one planar indicium that permits the user to personalize the assembly to their aesthetic. In addition to the modularity offered by the detachable fasteners, the screen apparatus affords the user a tiered or overlapping optional modular indicium, whereupon the user may assign the aforementioned to at least one side of the screen to facilitate adjustment and further personalization of the screen. Further, through a weight biasing bar with internal bar cavities, an electrical assembly comprising a power storage and processor system may be disposed. Additionally, with at least one illuminator and at least one speaker, the electrically assembly may be operated by the user through at least one switch and/or a personal computing device to afford greater engagement with the screening element. The user may impact the lighting or sound of an immediate area more directly while simultaneously offering the user greater personalization. Thus, the screen apparatus can address the conventional detrimental assignment of screen elements, in particular, those of vehicles including RVs, through a modular mounting device and coupler to a screen element with personalized indicia thereon. Through further elaboration the screen apparatus strengthens the personalization of the apparatus to the user through a modular indicium assignment system alongside a processor system that can facilitate the manipulation of illumination and sound.

### BRIEF DESCRIPTION OF THE DRAWINGS

FIG. 1 is a depiction of the exemplified screen apparatus as applied to a recreational vehicle, wherein the plurality of fasteners is observed in connection to the screen and the at least one weight biasing bar is forcing the top perimetric edge of the screen to overlap the plurality of apertures. It is further observed that the plurality of apertures is additionally located at the bottom corners of the screen.

FIG. 2 is a depiction of the apparatus thereof, where an individual fastener of the plurality of fasteners is observed. The mounting device comprises a suction cup that is connected to a coupler. Further the at least one weight biasing bar is observed in connection to the top perimetric edge of the screen.

FIG. 3 is a depiction of the apparatus thereof, wherein a mounting device comprises a suction cup that is connected to a coupler, and wherein the coupler comprising a hook is attached to one of the plurality of apertures of the screen.

FIG. 4 is a depiction of the apparatus thereof, wherein the coupler is engaging with an individual aperture of the plurality of apertures of the screen apparatus, and wherein a grommet is disposed within the individual aperture.

FIG. 5 is a depiction of an individual fastener of the plurality of fasteners, wherein the mounting device is rendered to the extraneous surface of the vehicle, and wherein the coupler consists a hook that is connected outwardly from the mounting device.

FIG. 6 is a depiction of an alternate embodiment of the apparatus where a planar indicium is observed alongside the plurality of apertures that is located along the perimetric edges of the screen.

FIG. 7 is a depiction of the vehicle without attachment of the screen apparatus of the present invention.

FIG. 8 is an electrical diagram of an electrical assembly of the screen apparatus of the present invention.

### DETAIL DESCRIPTIONS OF THE INVENTION

All illustrations of the drawings are for the purpose of describing selected versions of the present invention and are not intended to limit the scope of the present invention.

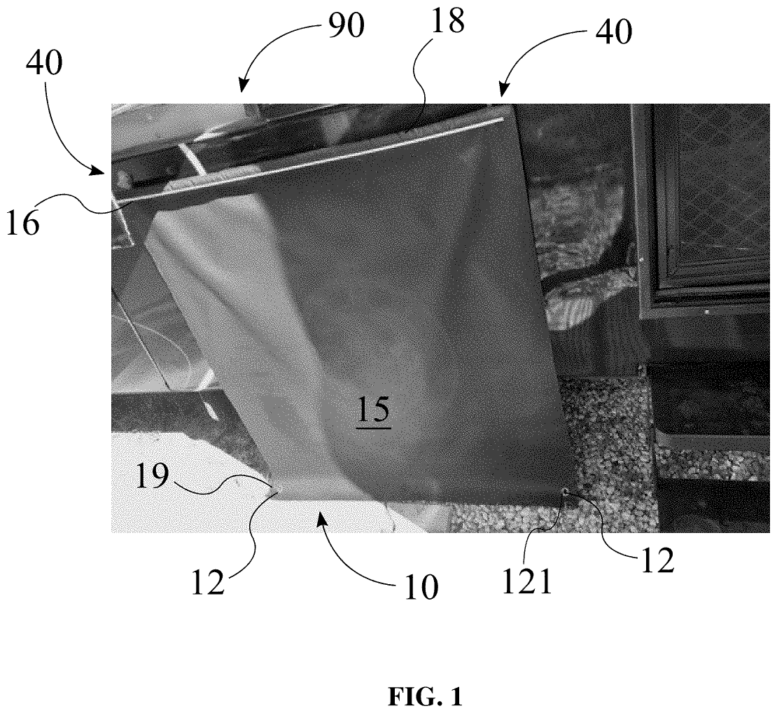

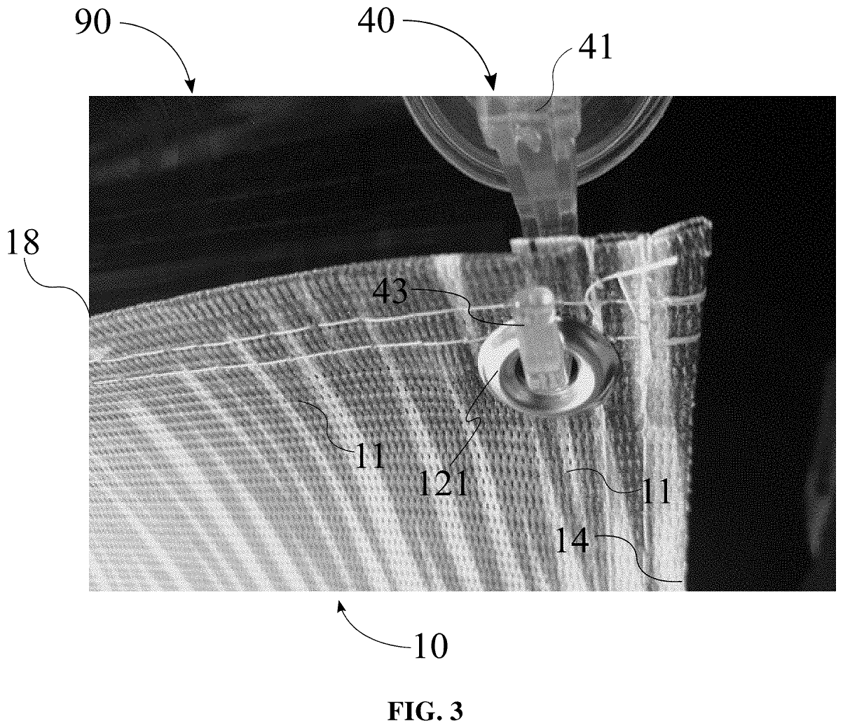

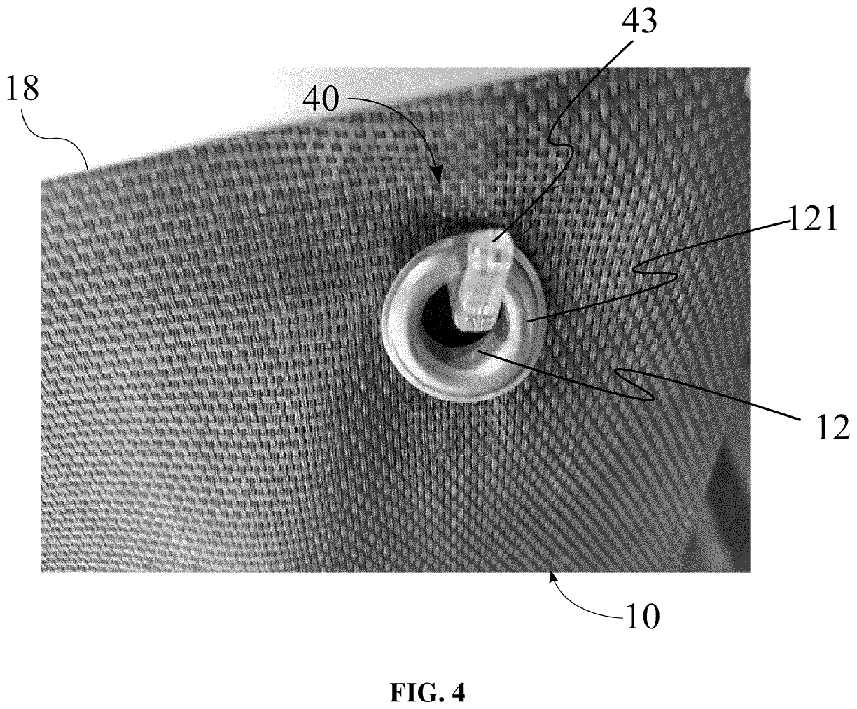

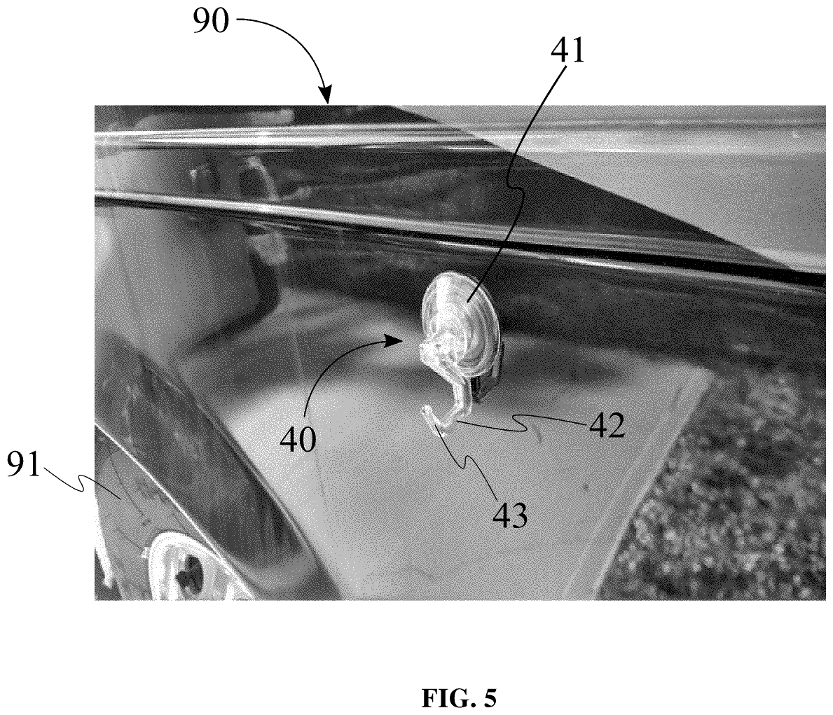

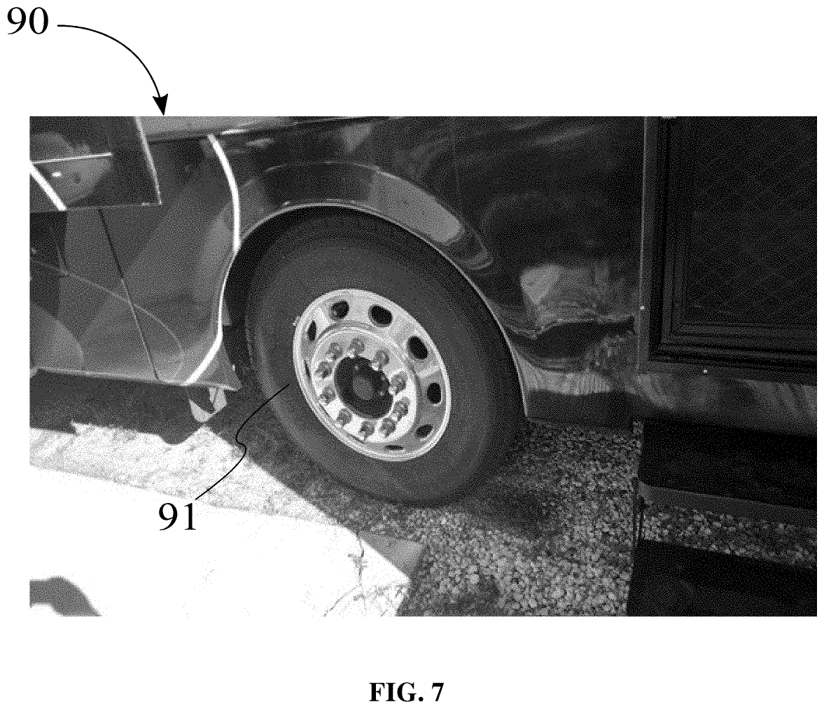

As can be seen in FIG. 1 to FIG. 8, the present invention comprises a detachable and noninvasive screen apparatus, also called “Fiber Screen”, for protecting an exterior part of a stationary vehicle from any potential damages caused by sun exposure, weather, insects, animals, etc. The screen apparatus of the present invention can be detachably and noninvasively applied to an exterior surface of the vehicle, including, but not limited to, a recreational vehicle (RV), to protect exterior parts such as wheels, tires, from sun exposure damage and any other potential damage applied to the stationary vehicle. The screen apparatus can be attached to the vehicle's body using detachable fasteners and provide a plurality of interactive features and mutable aesthetics to a user.

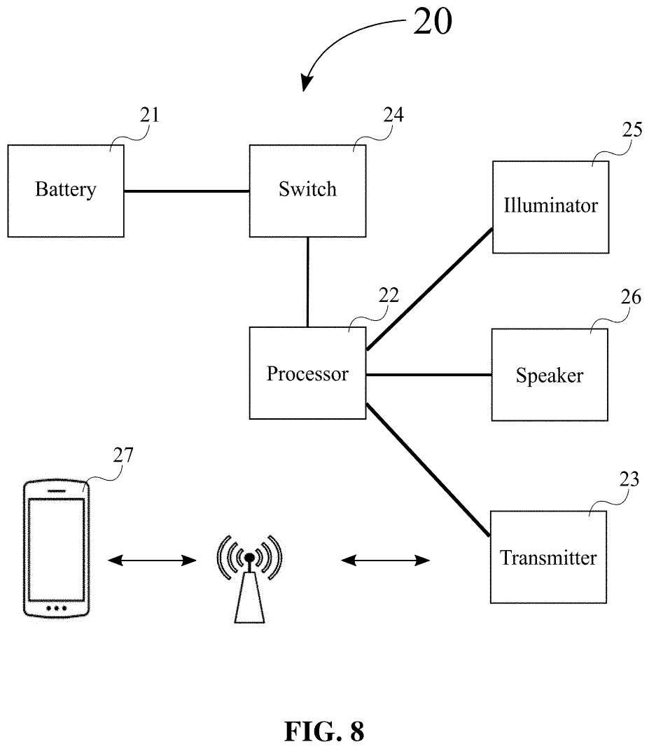

As can be seen in FIG. 1 to FIG. 7, the screen apparatus of the present invention functions as a modular shielding device to protect the vehicle, as can be seen without the present invention installed in FIG. 8. The screen apparatus comprises a screen 10 and a plurality of fasteners 40. The screen 10 comprises a first edge 18, a second edge 19, and a plurality of apertures 12. The first edge 18 and the second edge 19 are terminally positioned across the screen 10, opposite each other. The plurality of apertures 12 is distributed across the screen 10 adjacent the first edge 18. Each of the plurality of fasteners 40 comprises a mounting device 41 and a coupler 42. The coupler 42 is terminally connected to the mounting device 41. Each of the plurality of fasteners 40 is detachably and noninvasively attached to an exterior surface of the vehicle 90 through the mounting device 41. Further, each of the plurality of fasteners 40 is detachably attached to each of the plurality of apertures 12 of the screen 10 through the coupler 42. In the preferred embodiment, the plurality of fasteners 40 is mounted upon an extraneous surface of the vehicle 90, planar or minimally arcuate such as the side of the vehicular body. The plurality of fasteners 40 is arranged at points coincident with the plurality of apertures 12 of the screen 10, in whole or in part, to permit coupling with the screen 10. Each of the plurality of fasteners 40 is preferably modular at either the mounting device 41, the coupler 42, or both to facilitate rapid application on and removal from the extraneous surface of the vehicle 90.

As can be seen in FIG. 1 to FIG. 6, the screen 10 further comprises a plurality of pores 11, a first side 13, a second side 14, and at least one planar indicium 15. The screen 10 is a generally planar, flowing surface that is associated to the plurality of fasteners 40 through the plurality of apertures 12 and a grommet 121 of each of the plurality of apertures 12 thereat preferably. The screen 10 is further preferably rectilinear in profile and reversible. However other shapes may be utilized, including, but not limited to, curvilinear, polygonal, organic, and so on. The first side 13 and second side 14 are terminally positioned between the first edge 18 and the second edge 19, opposite each other. The plurality of pores 11 is distributed on the screen 10 and passes through the screen 10. Preferably equal or greater in surface area than the screen material and dispersed thereacross is the plurality of pores 11. The plurality of pores 11 is oriented normal to the planar surface of the screen 10 and passing therethrough. The individual pores 11 of the plurality of pores 11 are preferably of a size large enough to permit the transmission of fluids and vapors therethrough, while simultaneously small enough to mitigate the passage of pests and vermin. Preferably the plurality of pores 11 is arranged into a mesh configuration or else wise uniformly clustered about the screen 10.

As can be seen in FIG. 1 to FIG. 6, the plurality of apertures 12 of the screen 10 is located preferably nearest the perimetric corners, and adjacent all four edges, the first edge 18, the second edge 19, the first side 13, and the second side 14 of the screen 10 and passing normal therethrough. Each of the plurality of apertures 12 further comprises the grommet 121. The grommet 121 is concentrically attached to each of the plurality of apertures 12. The plurality of apertures 12 suits preferably the grommet 121 therein that facilitates engagement with the coupler 42 of each of the plurality of fasteners 40. Each of the plurality of apertures 12 is preferably curvilinear in profile to facilitate a greater number of couplers 42 to engage therewith. The plurality of apertures 12 may be disposed along the perimetric edges of the screen 10, the first edge 18, the second edge 19, the first side 13, and the second side 14, to permit engagement with additional accessories. The grommet 121 is concentric with the individual aperture of the plurality of apertures 12 in the preferred embodiment. Additionally, the grommet 121 mitigates the fraying of the screen 10 about each of the plurality of apertures 12. The grommet 121 further engages with the coupler 42 that thereafter facilitates assignment of the screen 10 to the plurality of fasteners 40 and simultaneously the extraneous surface of the vehicle 90. While preferably the grommet 121 is employed in the exemplified embodiment, the grommet 121 may be substituted with a receiving structure complementing alternative coupler. The at least one planar indicium 15 is disposed on at least one side or planar surface of the screen 10, opposite the exterior surface of the vehicle 90. The at least one planar indicium 15 is permanently assigned to the screen 15 through the application of pigment, paint, weaved throughout, and so on. Preferably the at least one planar indicium 15 is an inert pigmentation, although other applicable designs may incorporate photoluminescent pigmentation, photochromatic pigmentation, and so on, without obstructing the plurality of pores 11.

As can be seen in FIG. 1 to FIG. 6, the screen apparatus comprises at least one weight biasing bar 16. The at least one weight biasing bar 16 is disposed along the first edge 18, and/or the second edge 19, of the screen 10. More specifically, the at least one weight biasing bar 16 is mounted to the screen 10 preferably through clamping or fastening means. The at least one weight biasing bar 16 further comprises at least one bar cavity 17. The at least one bar cavity 17 is concentrically positioned within the at least one weight biasing bar 16. Additionally, the at least one bar cavity 17 is arbitrarily disposed within the individual weight-biasing bar 16. When mounted at the top of the screen 10, the at least one weight biasing bar 16 facilitates the retention of the screen 10 to the plurality of fasteners 40 in a hook 43 embodied coupler 42. Elsewise, the at least one weight biasing bar 16 may overlap and occlude the coupler 42 and grommet 121. Further, the at least one weight biasing bar 16 may be attached to the screen 10 adjacent the second edge 19. When the at least one weight biasing bar 16 is disposed along the bottom of the screen 10, the screen apparatus mitigates the passage of pests and vermin beneath the screen 10 if the screen 10 is in contact with or near flush with the ground.

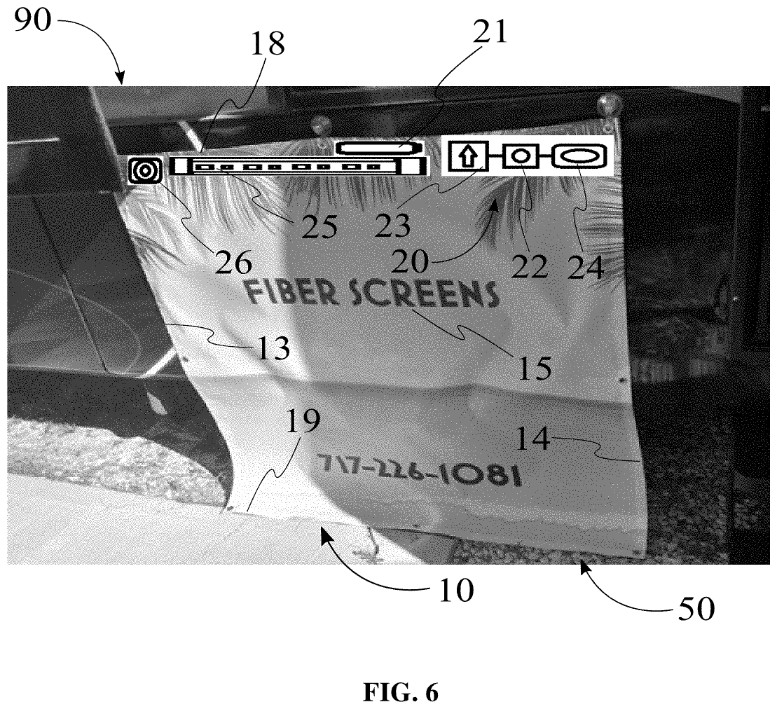

As can be seen in FIG. 6 and FIG. 8, the screen apparatus comprises an electrical assembly 20. The electrical assembly 20 provides interactive features to the user to benefit the use of the present invention. The electrical assembly 20 is internally attached to at least one bar cavity 17 of the at least one weight biasing bar 16. More specifically, the electrical assembly 20 comprises a power storage 21, a processor 22, a transmitter 23, at least one switch 24, at least one illuminator 25, at least one speaker 26, and an extraneous personal computing (PC) device 27. The at least one switch 24 is electrically connected to the power storage 21. The processor 22 is electrically connected to the at least one switch 24. The transmitter 23 and the illuminator 25 are electrically connected to the processor 22. The at least one speaker 26 is electrically connected to the processor 22. The at least one switch 24 is exteriorly positioned on the at least one weight biasing bar 16. Further, the PC device 27 is an extraneous device of the user and is wirelessly connected to the processor 22 through the transmitter 23. The at least one bar cavity 17 houses electrical assembly 20. In a count greater than one, the at least one bar cavity 17 (or the plurality thereof), is preferably interconnected by an arbitrary plurality of channels that provides passage to a plurality of wires. Further, the at least one bar cavity 17 may possess a plurality of holes that exposes the power storage 21, the at least one switch 24, the at least one illuminator 25, and the at least one speaker 26. Disposed arbitrarily within the at least one bar cavity 17 is the power storage 21 of the electrical assembly 20. The power storage 21 is connected to the processor 22 through a plurality of wires. The power storage 21 provides electrical energy necessary for the processor 22 to operate the electrical assembly 20 including the at least one illuminator 25 and the at least one speaker 26. The power storage 21 is preferably a replaceable medium such as a battery that is accessed through a closure disposed arbitrarily along one planar surface of the at least one weight biasing bar 16. However other means of power storage may be disposed such as, but not limited to, rechargeable mediums possessing access through a jack or inductive power means, solar power, and so on. Further, the processor 22 may include an arbitrary plurality of wires that connects the processor 22 to the power storage 21, the at least one switch 24, the at least one illuminator 25, and the at least one speaker 26. The processor 22 may further comprise the transmitter 23 that facilitates communication with an extraneous PC device 27 including, but not limited to, a mobile phone, a smartphone, a smart watch, a tablet, a hand-held laptop computer, etc. The processor 22 facilitates operation of the at least one illuminator 25 and the at least one speaker 26 through commands received by the transmitter 23. Elsewise, operation is achieved through a memory storage that permits interpretation of the inputs provided by the at least one switch 24. Preferably located and exposed upon a major surface of the at least one weight biasing bar 16 is the at least one switch 24. The at least one switch 24 is connected to the processor 22 through a plurality of wires. The at least one switch 24 may comprise any manner of input reasonably accommodated to a planar surface including, but not limited to, flip switches, depressible switches, touch screens, photosensitive switches, turn based switches, slider switches and so on. The engagement of the at least one switch 24 facilitates a change in the operation of the at least one illuminator 25 and the at least one speaker 26. Disposed preferably along at least one longitudinal surface of the at least weight biasing bar 16 is the at least one illuminator 25. The at least one illuminator 25 (or the plurality thereof) is connected to the processor 22 through the plurality of wires. Further, the at least one illuminator 25 is operated by the processor 22 as determined by the input of the at least one switch 24 or transmitter 23. The at least one illuminator 25 may project light either at the screen 10 or parallel therewith as directed by the plurality of holes. Further, the at least one illuminator 25 may be directed outward from the major surface of the at least one weight-biasing bar 16 to flood the immediate area with illumination. The at least one speaker 26 may be exposed along the major surface of the individual weight biasing bar 17 arbitrarily near either distal end or the center. The at least one speaker 26 is connected to the processor 22 through the plurality of wires. The at least one speaker 26 is provided audio information from transmitter 23 or the memory storage of the processor 22. The operation of the at least one speaker 26 can be facilitated through the at least one switch 24 (or the plurality thereof) to control activation, volume, selection, and so on. Elsewise the operation of the at least one speaker 26 may be achieved through commands received through the transmitter 23.

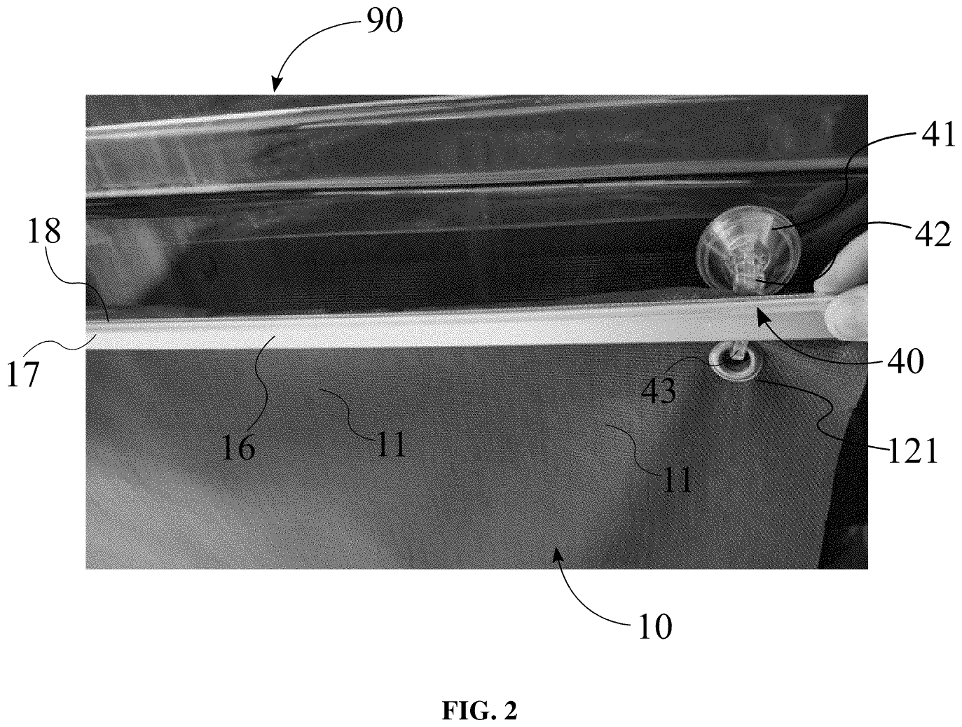

As can be seen in FIG. 2 to FIG. 5, the mounting device 41 of the plurality of fasteners 40 is disposed at one end of each of the plurality of fasteners 40 nearest the extraneous surface of the vehicle 90. In the preferred embodiment, the mounting device 41 facilitates modular engagement between each the plurality of fasteners 40 and the extraneous surface of the vehicle 90. Additionally, the mounting device 41 may operate through a suction mounting device 41 to mount to the extraneous surface of the vehicle 90. However, the mounting device 41 can be employed as a device including, but not limited to, self-locking mounting device, suction mounting device, magnetic mounting device, self-locating geometry, tension-release adhesives, and so on. In some embodiment of the present invention, the mounting device 41 takes form of a self-locking mounting device, which includes a locking mechanism located between the coupler 42 and the mounting device 41. The locking mechanism of the mounting device 41 is engaged through manipulation of the coupler 42 relative to the mounting device 41 rigidly mounted to the extraneous surface of the vehicle 90. Preferably the locking mechanism of the mounting device 41 comprises a piston lock that is actuated through pivoting motion from the coupler 42 to magnify the retaining strength of the mounting device 41. However, other locking mechanisms may be employed including, but not limited to, rotary tightening by a screw or knob, lever operated, and so on. Disposed at the opposing end of each of the plurality of fasteners 40, furthest from the extraneous surface of the vehicle 90, is the coupler 42. The coupler 42 is disposed on the exterior facing surface of the mounting device 41 and arrested in translational motion thereto. In the preferred embodiment of the present invention, the coupler 42 comprises a hook 43 that engages with the grommet 121 of the plurality of apertures 12 to facilitate rapid removal and manipulation of the screen 10 with the plurality of fasteners 40. However, any other coupler 42 can be utilized including, but not limited to: snap fitting, self-locating geometry, magnetism, and so on.

As can be seen in FIG. 1 and FIG. 6, the modular indicium 50 of the screen apparatus of the present invention comprises a plurality of complementing indicia fasteners 51, a hanging ornament 52, a hooking device 53, and a plurality of indicia pores 54. The plurality of indicia fasteners 51 is terminally and perimetrically attached to the hanging ornament 52. The modular indicium 50 is detachably attached to the screen 10 by mounting each of the plurality of indicia fasteners 51 to one of the plurality of apertures 12 of the screen 10. The plurality of indicia pores 54 is distributed on the modular indicium 50 and passes through the modular indicium 50 to create penetrations to allow the transmission of fluids and vapors therethrough, while simultaneously small enough to mitigate the passage of pests and vermin. The modular indicium 50 may be provided that can be administered to the screen 10. The hanging ornament 52 of the modular indicium 50 is afforded similar function and structure to that of the at least one planar indicium 15. Further, the hanging ornament 52 may comprise a plurality of ornaments that can be mounted through a hooking device 53 that perforates through an individual pore of the plurality of pores 54. The modular indicium 50 occludes the at least one planar indicium 15 of the screen 10 when mounted thereto. Similar to the screen 10, the modular indicium 50 preferably possesses a respective plurality of indicium pores 54 that facilitates ventilation therethrough. Located preferably within the corners of the modular indicium 50 is the plurality of indicia fasteners 51. The plurality of indicia fasteners 51 engages with the plurality of apertures 12 of the screen 10, securing the modular indicium 50 to the screen 10. The plurality of indicia fasteners 51 may comprise any number of modular fastening means including, but not limited to: magnets, snap fits, self-locating geometry, hooks, and so on.

Although the invention has been explained in relation to its preferred embodiment, it is to be understood that many other possible modifications and variations can be made without departing from the spirit and scope of the invention as hereinafter claimed.

What is claimed is:

1. A detachable and noninvasive screen apparatus for protecting an exterior part of a stationary vehicle comprising:
a screen;
a plurality of fasteners;
the screen comprising a first edge, a second edge, and a plurality of apertures;
the first edge and the second edge being terminally positioned across the screen, opposite each other;
the plurality of apertures being distributed across the screen adjacent the first edge;
each of the plurality of fasteners comprising a mounting device and a coupler;
the coupler being terminally connected to the mounting device;
each of the plurality of fasteners being detachably and noninvasively attached to an exterior surface of the vehicle through the mounting device; and
each of the plurality of fasteners being detachably attached to each of the plurality of apertures of the screen through the coupler.

2. The detachable and noninvasive screen apparatus for protecting an exterior part of a stationary vehicle as claimed in claim 1 comprising:
at least one weight biasing bar;
the at least one weight biasing bar comprising at least one bar cavity;
the at least one bar cavity being concentrically positioned within the at least one weight biasing bar; and
the at least one weight biasing bar being attached to the screen adjacent the first edge.

3. The detachable and noninvasive screen apparatus for protecting an exterior part of a stationary vehicle as claimed in claim 2 comprising:
an electrical assembly;
the electrical assembly comprising: a power storage, a processor, a transmitter, at least one switch, at least one illuminator, and at least one speaker;
the at least one switch being electrically connected to the power storage;
the processor being electrically connected to the at least one switch;
the transmitter and the at least one illuminator being electrically connected to the processor;
the speaker being electrically connected to the processor;
the electrical assembly being internally attached to at least one bar cavity of the at least one weight biasing bar; and
the at least one switch being exteriorly positioned on the at least one weight biasing bar.

4. The detachable and noninvasive screen apparatus for protecting an exterior part of a stationary vehicle as claimed in claim 3 comprising:
the electrical assembly comprising a personal computing (PC) device; and
the PC device being wirelessly connected to the processor through the transmitter.

5. The detachable and noninvasive screen apparatus for protecting an exterior part of a stationary vehicle as claimed in claim 2, wherein the at least one weight biasing bar being attached to the screen adjacent the second edge.

6. The detachable and noninvasive screen apparatus for protecting an exterior part of a stationary vehicle as claimed in claim 1 comprising:
the screen comprising a plurality of pores;
the plurality of pores being distributed on the screen; and
the plurality of pores passing through the screen.

7. The detachable and noninvasive screen apparatus for protecting an exterior part of a stationary vehicle as claimed in claim 1 comprising:
each of the plurality of apertures comprising a grommet; and
the grommet being concentrically attached to each of the plurality of apertures.

8. The detachable and noninvasive screen apparatus for protecting an exterior part of a stationary vehicle as claimed in claim 1 comprising:
at least one planar indicium; and
at least one planar indicium being positioned on the screen opposite the exterior surface of the vehicle.

9. The detachable and noninvasive screen apparatus for protecting an exterior part of a stationary vehicle as claimed in claim 1 comprising:
a modular indicium;
the modular indicium comprising a hanging ornament and a plurality of indicia fasteners;
the plurality of indicia fasteners being terminally and perimetrically attached to the hanging ornament; and
the modular indicium being detachably attached to the screen by mounting each of the plurality of indicia fasteners to one of the plurality of apertures of the screen.

10. The detachable and noninvasive screen apparatus for protecting an exterior part of a stationary vehicle as claimed in claim 9 comprising:
the modular indicium comprising a plurality of indicia pores;
the plurality of indicia pores being distributed on the modular indicium; and
the plurality of indicia pores passing through the modular indicium.

11. The detachable and noninvasive screen apparatus for protecting an exterior part of a stationary vehicle as claimed in claim 1, wherein the mounting device of each of the plurality of fasteners comprising a self-locking mounting device.

12. The detachable and noninvasive screen apparatus for protecting an exterior part of a stationary vehicle as claimed in claim 1, wherein the mounting device of each of the plurality of fasteners comprising a suction mounting device.

13. The detachable and noninvasive screen apparatus for protecting an exterior part of a stationary vehicle as claimed in claim 1, wherein the mounting device of each of the plurality of fasteners comprising a magnetic mounting device.

14. The detachable and noninvasive screen apparatus for protecting an exterior part of a stationary vehicle as claimed in claim 1, wherein the coupler of each of the plurality of fasteners comprising a hook.

15. A detachable and noninvasive screen apparatus for protecting an exterior part of a stationary vehicle comprising:
a screen;
a plurality of fasteners;
at least one weight biasing bar;
the screen comprising a first edge, a second edge, a plurality of apertures;
the first edge and the second edge being terminally positioned across the screen, opposite each other;
the plurality of apertures being distributed across the screen adjacent the first edge;
each of the plurality of fasteners comprising a mounting device and a coupler;
the coupler being terminally connected to the mounting device;
each of the plurality of fasteners being detachably and noninvasively attached to an exterior surface of the vehicle through the mounting device;
each of the plurality of fasteners being detachably attached to each of the plurality of apertures of the screen through the coupler;
the at least one weight biasing bar comprising at least one bar cavity;
the at least one bar cavity being concentrically positioned within the at least one weight biasing bar; and
the at least one weight biasing bar being attached to the screen adjacent the first edge.

16. The detachable and noninvasive screen apparatus for protecting an exterior part of a stationary vehicle as claimed in claim 15 comprising:
an electrical assembly;
the electrical assembly comprising: a power storage, a processor, a transmitter, at least one switch, at least one illuminator, and at least one speaker;
the at least one switch being electrically connected to the power storage;
the processor being electrically connected to the at least one switch;
the transmitter and the at least one illuminator being electrically connected to the processor;
the speaker being electrically connected to the processor;
the electrical assembly being internally attached to at least one bar cavity of the at least one weight biasing bar; and
the at least one switch being exteriorly positioned on the at least one weight biasing bar.

17. The detachable and noninvasive screen apparatus for protecting an exterior part of a stationary vehicle as claimed in claim 15 comprising:
the screen comprising a plurality of pores;
the plurality of pores being distributed on the screen; and
the plurality of pores passing through the screen.

18. The detachable and noninvasive screen apparatus for protecting an exterior part of a stationary vehicle as claimed in claim 15 comprising:
at least one planar indicium; and
at least one planar indicium being positioned on the screen opposite the exterior surface of the vehicle.

19. The detachable and noninvasive screen apparatus for protecting an exterior part of a stationary vehicle as claimed in claim 15 comprising:
a modular indicium;
the modular indicium comprising a hanging ornament, a plurality of indicia fasteners, and a plurality of indicia pores;
the plurality of indicia pores being distributed on the modular indicium;
the plurality of indicia pores passing through the modular indicium;
the plurality of indicia fasteners being terminally and perimetrically attached to the hanging ornament; and
the modular indicium being detachably attached to the screen by mounting each of the plurality of indicia fasteners to one of the plurality of apertures of the screen.

20. A detachable and noninvasive screen apparatus for protecting an exterior part of a stationary vehicle comprising:
a screen;
a plurality of fasteners;
at least one weight biasing bar;
an electrical assembly
the screen comprising a first edge, a second edge, a plurality of apertures;
the first edge and the second edge being terminally positioned across the screen, opposite each other;
the plurality of apertures being distributed across the screen adjacent the first edge;
each of the plurality of fasteners comprising a mounting device and a coupler;
the coupler being terminally connected to the mounting device;
each of the plurality of fasteners being detachably and noninvasively attached to an exterior surface of the vehicle through the mounting device;
each of the plurality of fasteners being detachably attached to each of the plurality of apertures of the screen through the coupler;
the at least one weight biasing bar comprising at least one bar cavity;
the at least one bar cavity being concentrically positioned within the at least one weight biasing bar;
the at least one weight biasing bar being attached to the screen adjacent the first edge;
the electrical assembly comprising: a power storage, a processor, a transmitter, at least one switch, at least one illuminator, at least one speaker, and a personal computing (PC) device;
the at least one switch being electrically connected to the power storage;
the processor being electrically connected to the at least one switch;
the transmitter and the at least one illuminator being electrically connected to the processor;
the speaker being electrically connected to the processor;
the PC device being wirelessly connected to the processor through the transmitter;
the electrical assembly being internally attached to at least one bar cavity of the at least one weight biasing bar; and
the at least one switch being exteriorly positioned on the at least one weight biasing bar.
